(19) United States
(12) Patent Application Publication
(10) Pub. No.: US 2020/0097866 A1
(43) Pub. Date: Mar. 26, 2020

(54) PROJECT RESOURCE RISK MANAGEMENT

(71) Applicant: International Business Machines Corporation, Armonk, NY (US)

(72) Inventors: Kelley Anders, East New Market, MD (US); Jonathan Dunne, Dungarvan (IE); Jeremy R. Fox, Georgetown, TX (US); Liam S. Harpur, Dublin (IE)

(21) Appl. No.: 16/139,468

(22) Filed: Sep. 24, 2018

(51) Int. Cl. G06Q 10/06; G06Q 10/10; G06N 7/00

(52) U.S. Cl. CPC G06Q 10/0635; G06Q 10/063112; G06N 7/005; G06Q 10/1091; G06Q 10/06398

(57) ABSTRACT

The method, computer program product and computer system may include computing device which may collect worker data associated with one or more workers and identify previously completed tasks associated with the workers. The computing device may determine a task completion rate for each one of the workers and generate a visual model illustrating the completion rate of each of the workers. The computing device may determine one or more factors associated with the completed tasks such as positive feedback, negative feedback, timelines of task completion, and length of task completion. The computing device may receive a new task to be assigned to the workers and determine the bandwidth required to complete the new task. The computing device may generate a follow-through risk notification associated with each of the workers.

### BACKGROUND

The present invention relates generally to a method, system, and computer program for project resource risk management. More particularly, the present invention relates to a method, system, and computer program for assigning a task to an individual based on an individual's performance history.

In the world of project management, there exists the need to reliably procure and deploy resources to deliver on schedule and within budget, while still delivering the agreed to scope. The triple constraint of time, cost, and scope describe the project with one constraint affecting one or both of the other constraints. Further, quality is affected by all three constraints and is, therefore, a central theme. Quality is also defined by the project scope and is an output of the scope definition. When it comes to assigning tasks to among a team of individuals in a project, careful consideration must made as to who will deliver the best results. For example, a project manager tasked with managing and delivering the outcomes for a Project A has a new task he needs completed. The project manager may have five people on the team assigned to Project A and based on the skills needed, the project manager has narrowed the choice down to three people. All three are technically brilliant, but the project manager needs to assign the new task to the individual who will best complete the task on schedule and within budget.

### BRIEF SUMMARY

An embodiment of the invention may include a method, computer program product and computer system for project resource risk management. The method, computer program product and computer system may include computing device which may collect worker data associated with one or more workers and identify previously completed tasks associated with the one or more workers from the worker data. The computing device may determine a task completion rate for each one of the one or more workers and generate a visual model, such as a probability model, illustrating the completion rate of each of the one or more workers. The computing device may determine one or more factors associated with the completed tasks of one or more workers such as positive feedback, negative feedback, timelines of task completion, and length of task completion. The computing device may receive a new task to be assigned to the one or more workers and determine the bandwidth required to complete the new task, the bandwidth being an estimated amount of time to complete the new task, the resources necessary to complete the new task, and the skills required to complete the new task. The computing device may generate a follow-through risk notification associated with each one of the one or more workers, the follow-through risk notification indicating one or more of the factors associated with the completed tasks of one or more workers. The computing device may transmit the worker data, the task completion rate for the one or more workers, and the visual model to a machine learning system.

### BRIEF DESCRIPTION OF THE DRAWINGS

FIG. 1a illustrates a system for project resource risk management, in accordance with an embodiment of the invention.

FIG. 1b illustrates example operating modules of the project resource risk management system of FIG. 1a;

FIG. 2 is a flowchart illustrating an example method of the project resource risk management, in accordance with an embodiment of the invention.

FIG. 3 is a block diagram depicting the hardware components of the project resource risk management system of FIG. 1, in accordance with an embodiment of the invention.

FIG. 4 illustrates a cloud computing environment, in accordance with an embodiment of the invention.

FIG. 5 illustrates a set of functional abstraction layers provided by the cloud computing environment of FIG. 4, in accordance with an embodiment of the invention.

### DETAILED DESCRIPTION

Embodiments of the present invention will now be described in detail with reference to the accompanying Figures.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention provides a method, computer program, and computer system for assigning a task to an individual based on an individual's performance history. Current technology does not allow for the collection and analysis of social media data and computer application data to enable the modeling of a worker's task completion, i.e. probability that a worker will complete a task assigned to him/her. Further, current technology fails to allow a user to determine factors associated with a worker's task completion such as positive feedback, negative feedback, timelines of task completion, and length of task completion. Embodiments of the present invention also improves current technology by enabling the determination of the bandwidth required by a new task. For example, the embodiments of the present invention may provide an estimated amount of time to complete the new task, the resources necessary to complete the new task, and the skills required to complete the new task. Embodiments of the present invention also improves current technology by allowing for the generation of a follow-through risk notification associated with each one of one or more workers indicating one or more of the factors associated with the completed tasks of one or more workers.

Embodiments of the present invention may improve existing question/answer (QA) systems by adding the corpus of data used by the QA system. An example of a QA system may be the IBM Watson™ QA system available from International Business Machines Corporation of Armonk, N.Y., which is augmented with the mechanisms of the illustrative embodiments of the present invention described hereafter. The QA system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity. The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question. The data collected, analyzed, and generated by embodiments of the present invention, as described herein, may be added to the corpus of data of a QA system. Thus, the collected, analyzed, and generated by embodiments of the present invention may be utilized by the QA system to generate an answer to a question. For example, a user might input a question regarding task assignment and the QA system may utilize the data of the present invention to formulate an answer.

Reference will now be made in detail to the embodiments of the present invention, examples of which are illustrated in the accompanying drawings, wherein like reference numerals refer to like elements throughout. Embodiments of the invention are generally directed to a system for predicting the motivational predisposition of an individual.

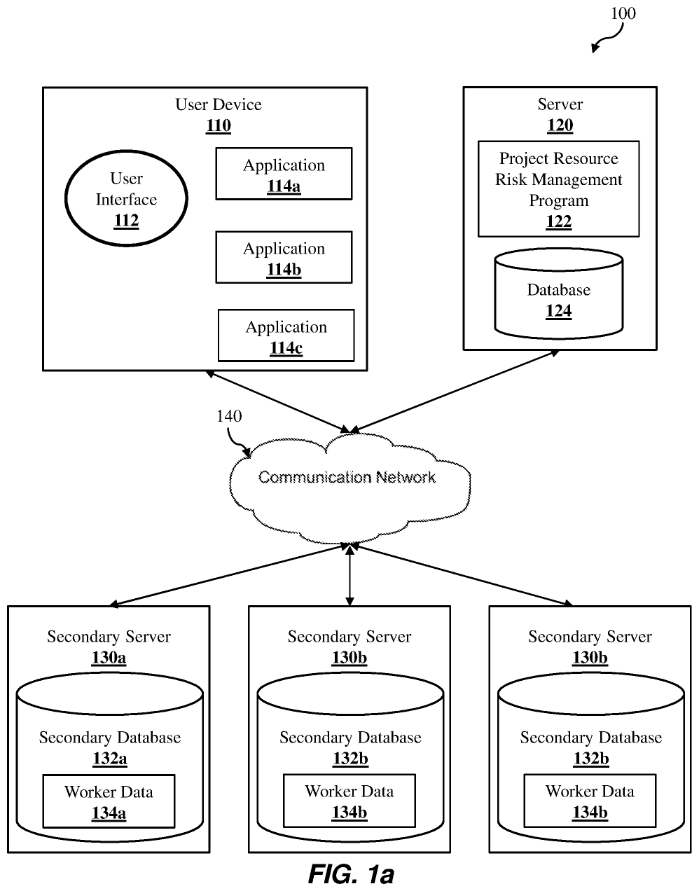

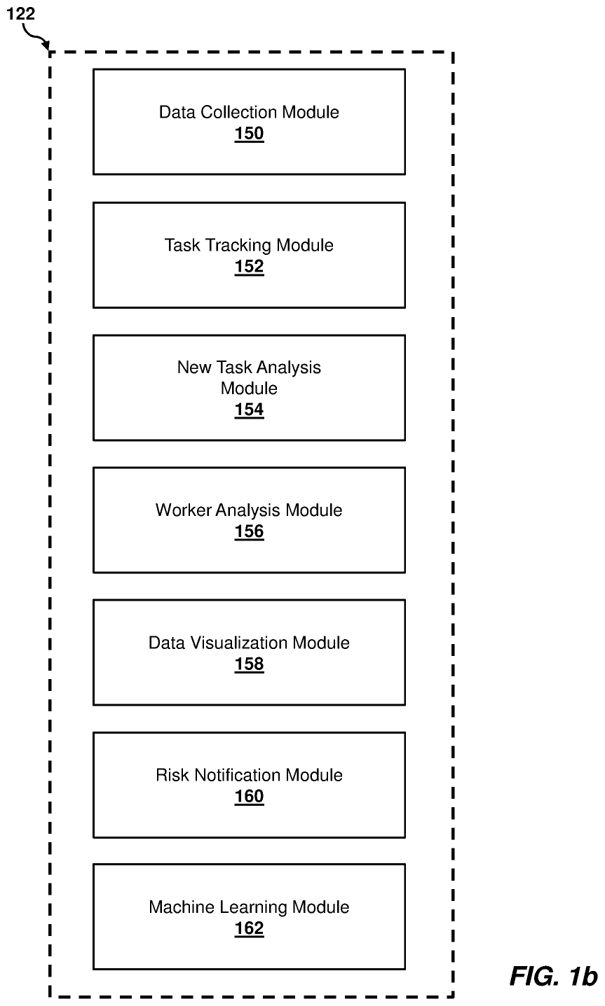

FIG. 1 illustrates a project resource risk management system 100, in accordance with an embodiment of the invention. In an example embodiment, project resource risk management system 100 includes a user device 110, a server 120, and secondary servers 130a-c, interconnected via network 140.

In the example embodiment, the network 140 is the Internet, representing a worldwide collection of networks and gateways to support communications between devices connected to the Internet. The network 140 may include, for example, wired, wireless or fiber optic connections. In other embodiments, the network 140 may be implemented as an intranet, a local area network (LAN), or a wide area network (WAN). In general, the network 140 can be any combination of connections and protocols that will support communications between the user device 110, the server 120, and the secondary servers 130a, 130b, 130c.

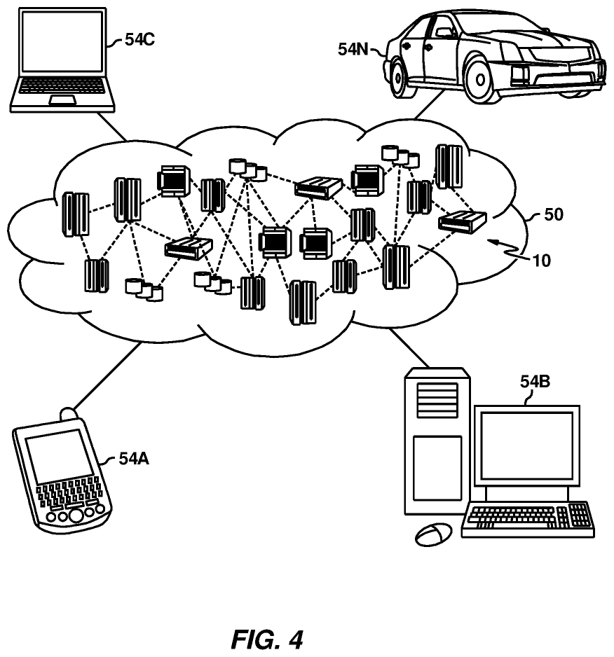

The user device 110 may include a user interface 112, and applications 114a, 114b, 114c. In the example embodiment, the user device 110 may be a desktop computer, a notebook, a laptop computer, a tablet computer, a thin client, or any other electronic device or computing system capable of storing compiling and organizing audio, visual, or textual content and receiving and sending that content to and from other computing devices, such as the server 120, and the secondary servers 130a, 130b, 130c via the network 140. While only a single user device 110 is depicted, it can be appreciated that any number of user devices may be part of the motivation prediction system 100. In some embodiments, the user device 110 includes a collection of devices or data sources. The user device 110 is described in more detail with reference to FIG. 4.

The user interface 112 includes components used to receive input from a user on the user device 110 and transmit the input to the project resource risk management program 122 residing on server 120, or conversely to receive information from the project resource risk management program 122 and display the information to the user on user device 110. In an example embodiment, the user interface 112 uses a combination of technologies and devices, such as device drivers, to provide a platform to enable users of the user device 110 to interact with the project resource risk management program 122. In the example embodiment, the user interface 112 receives input, such as but not limited to, textual, visual, or audio input received from a physical input device, such as but not limited to, a keypad and/or a microphone.

The applications 114a, 114b, 114c may be any computer application which has information relating to a worker's acceptance or agreement to complete a task and the worker's progress, and completion of tasks assigned to the worker, such as, but not limited to, social media applications, email applications, instant messaging applications, word processing applications, etc. Examples of such applications 114a, 114b, 114c may be Twitter®, Facebook®, Snapchat®, Instagram®, LinkedIn®, IBM® Connections, Microsoft Outlook®, Gmail®, Lotus Notes®, Microsoft® Word etc. The term worker refers to anyone, and may refer to one or more individuals, to whom the user of the user device 110 would assign a task in a project. The term worker may also refer to the user of the user device 110. For example, the user may be, but it not limited to, a project manager, and the worker may be, but it not limited to, one or more team members working under the project manager. While three applications 114a, 114b, 114c are illustrated, it can be appreciated that any number of applications may be part of the project resource risk management system 100 including less than three or more than three depending on the user. The data associated with applications 114a, 114b, 114c may be stored on secondary servers 130a, 130b, 130c associated with the application 114a, 114b, 114c, respectively. For example, a user on user device 110 may have Facebook®, Twitter®, and Gmail® accounts, i.e. applications 114a, 114b, 114c, and the data associated with each application 114a, 114b, 114c would be stored on the Facebook, Twitter, and Gmail® servers, i.e., secondary servers 130a, 130b, 130c.

The secondary servers 130a, 130b, 130c may include secondary databases 132a, 132b, 132c and worker data 134a, 134b, 134c. While three secondary servers 130a, 130b, 130c are illustrated, it can be appreciated that any number of secondary servers 130 may be part of the motivation prediction system 100 including less than three or more than three depending on the user. In the example embodiment, the secondary servers 130a, 130b, 130c may be a desktop computer, a notebook, a laptop computer, a tablet computer, a thin client, or any other electronic device or computing system capable of storing compiling and organizing audio, visual, or textual content and receiving and sending that content to and from other computing devices, such as the user device 110, and the server 120 via the network 140. In some embodiments, the secondary servers 130a, 130b, 130c include a collection of devices or data sources. The secondary servers 130a, 130b, 130c are described in more detail with reference to FIG. 4.

The secondary databases 132a, 132b, 132c may be a collection of the worker data 134a, 134b, 134c. The worker data 134a, 134b, 134c may be data relating to one or more workers' acceptance or agreement to perform one or more assigned tasks, e.g. anything by which a worker confirms a “Yes” to or an agreement to complete a task, and the progress and/or completion of one or more assigned tasks including, but not limited to, audio, visual, and textual files. For example, the worker data 134a, 134b, 134c may include, but is not limited to, social media feed posts, online messages, emails, tweets, calendar activities, meeting minutes, instant messages, SMS texts, etc. of the worker on applications 114a, 114b, 114c. The worker data 134a, 134b, 134c may also include, but is not limited to, the worker's interactions with applications 114a, 114b, 114c. For example, the worker data 134a, 134b, 134c may include, but it not limited to, how and posts and messages on the worker's Facebook® account, tweets on the worker's Twitter® account, messages on the worker's Gmail® or Lotus Notes account, etc. The worker may refer to, but is not limited to, friends of the user on Facebook®, followers of the user and accounts followed by the user on Twitter®, correspondents of the user on Gmail®, etc. The worker data 134a, 134b, 134c stored in secondary databases 132a, 132b, 132c located on the secondary servers 130a, 130b, 130c can be accessed through using the network 140.

The server 120 includes project resource risk management program 122 and database 124. In the example embodiment, the server 120 may be a desktop computer, a notebook, a laptop computer, a tablet computer, a thin client, or any other electronic device or computing system capable of storing compiling and organizing audio, visual, or textual content and receiving and sending that content to and from other computing devices, such as the user device 110 and the secondary servers 130a, 130b, 130c via network 140. The server 120 is described in more detail with reference to FIG. 4.

The project resource risk management program 122 is a program capable of collecting data from one or more workers' interactions and engagement with applications 114a, 114b, 114c and determining the risk probability that each worker will successfully complete an assigned task. For example, the project resource risk management program 122 may determine how many tasks one or more workers have previously accepted and how many of those tasks were completed on time and to the scope required. The project resource risk management program 122 may then recommend the best worker to complete a new task based on the determined risk probability. The project resource risk management program 122 is described in more detail with reference to FIG. 1b.

The database 124 may store the worker data 134a, 134b, 134c obtained from the secondary servers 130a, 130b, 130c by the project resource risk management program 122. The database 124 may also store the risk probabilities and data associated therewith as determined by the project resource risk management program 122. The database 124 is described in more detail with reference to FIG. 4.

FIG. 1b illustrates example modules of the project resource risk management program 122. In an example embodiment, the project resource risk management program 122 may include seven modules: data collection module 150, task tracking module 152, new task analysis module 154, worker analysis module 156, data visualization module 158, risk notification module 160, and machine learning module 162.

The data collection module 150 collects the worker data 134a, 134b, 134c associated with one or more workers identified from the secondary servers 130a, 130b, 130c associated with the applications 114a, 114b, 114c for processing. Continuing with the above example, the data collection module 150 may receive the worker data 134a, 134b, 134c of, for example, but not limited to, a project manager and the project manager's employees. In an alternative embodiment, the worker data 134a, 134b, 134c may be collected from the secondary servers 130a, 130b, 130c associated with the applications 114a, 114b, 114c and stored in database 124 and the data collection module 150 receives the worker data 134a, 134b, 134c from the database 124.

The task tracking module 152 identifies previously completed tasks assigned to the workers associated with the worker data 134a, 134b, 134c and determines if the previously assigned tasks were completed by the assigned worker, i.e. a completion rate. The task tracking module 152 may identify the previously completed assigned tasks and determine who completed those tasks using natural language processing (NLP) techniques. NLP techniques enable computers to derive meaning from human or natural language input, such as but not limited to, the worker data 134a, 134b, 134c. Utilizing NLP, large chunks of text are analyzed, segmented, summarized, and/or translated in order to alleviate and expedite a user's identification of relevant information. Thus, the task tracking module 152 may identify a worker who accepted or was assigned a previous task and further determine whether that worker completed the task or if another worker completed the task. In another embodiment of the invention, the task tracking module 152 may also determine factors contributing to the completion of the previously assigned tasks from the worker data 134a, 134b, 134c. The task tracking module 152 may determine factors such as, but not limited to, that a worker requires his/her project manager to constantly remind the worker of the assigned task, that a worker is more likely to complete a task if assigned with the knowledge of another person, such as, but not limited to, another colleague or another manager, etc. Further, the task tracking module 152 may identify other factors such as, but not limited to, previously completed tasks assigned to the workers associated with the worker data 134a, 134b, 134c. The task tracking module 152 may identify other factors such as, but not limited to, praise, i.e. positive feedback, received by a worker for a particular task, negative feedback received by a worker for a particular task, timely completion of previously assigned tasks, and how long a worker took to complete previously assigned tasks.

The new task analysis module 154 determines the bandwidth needed to complete a new task to be assigned to a worker. The new task analysis module 154 may analyze the new task using NLP and derive a model such as but not limited to, a latent class model, to determine the bandwidth required for the new task. The bandwidth may refer to, but it not limited to, an estimated amount of time the new task would take to complete, the resources necessary to completed the new task, and/or the skills required to complete the new task.

The worker analysis module 156 determines the probability of one or more workers completing the new task. The worker analysis module 156 may determine the probability based on the worker data 134a, 134b, 134c collected by the data collection module 150 the determined previous task completion by the task tracking module 152. The worker analysis module 156 may determine the probability of one or more workers completing the new task using one or more processes such as, but not limited to, simple binary regression, a Markov model with transition matrices, or completion probability. For example, the worker analysis module 156 using simple binary regression may determine from the worker data 134a, 134b, 134c, that worker A was presented with 100 tasks, that worker A said “yes” to all 100 tasks, but worker A only successfully completed 72 tasks. Thus, the worker analysis module 156 would determine, using simple binary regression, that worker A has a probability of 72% of completing an assigned task. In another example, the worker analysis module 156 using a Markov model may determine from the worker data 134a, 134b, 134c, that worker B said “yes” to 90% of tasks presented to worker B and that worker B completed tasks 60% of the time. Thus, the worker analysis module 156 would determine, using a Markov model, that worker B has a probability of 60% of completing an assigned task. In yet another example, the worker analysis module 156 using completion probability may determine from the worker data 134a, 134b, 134c, that worker C said “yes” to 5% of tasks presented to worker B and that worker B completed tasks 100% of the time. Thus, the worker analysis module 156 would determine, using completion probability, that worker C has a probability of 100% of completing an assigned task. Continuing with the examples above, the worker analysis module 156 may further determine that workers A and B have a higher probability of accepting or committing to a task with a lower probability of completing that task compared to worker C who has a low task commitment probability but a high task completion probability. The percent probability that a worker will agree to take on a task may be referred to as “optimism,” while the percent probability that a worker will successfully complete an assigned task may be referred to as “pragmatic realism.”

The data visualization module 158 generates a visual model illustrating the probability of the one or more workers associated with the worker data 134a, 134b, 134c will complete a newly assigned task. The data visualization module 158 may generate a display of the illustrated probabilities via the user interface 112 on user device 110. For example, the data visualization module 158 may present to the user of user device 110 a graph illustrating the probabilities for each worker associated with the worker data 134a, 134b, 134c indicating how likely each worker is to complete a newly assigned task. The data visualization module 158 may indicate the probability that each worker associated with the worker data 134a, 134b, 134c will accept and new task. The data visualization module 158 may, for example, indicate a higher probability with a darker color or with a higher bar graph.

The risk notification module 160 generates a follow-through risk notification to a user of the user device 110. The follow-through risk notification may indicate any risks associated with the one or more workers associated with the worker data 134a, 134b, 134c following through on assigned tasks. The risks may include the factors contributing to the completion of the previously assigned tasks from the worker data 134a, 134b, 134c identified by the task tracking module 152. The risk notification module 160 may display the generated follow-through risk notification via the user interface 112 on user device 110. For example, the generated follow-through risk notification may be any type of display notification, including but not limited to, a visual notification to alert the user of the user device 110 to any risks associated with a worker's task completion.

The machine learning module 162 feeds all the collected, analyzed, and generated data from the data collection module 150, task tracking module 152, new task analysis module 154, worker analysis module 156, data visualization module 158, and risk notification module 160 into an existing machine learning system. For example, the machine learning module 162 may feed all the collected, analyzed, and generated data into a machine learning system such as, but not limited to, IBM®'s Watson® and/or Scikit-learn®. Thus, the machine learning module 162 may help existing machine learning systems to better analyze and predict worker task completion.

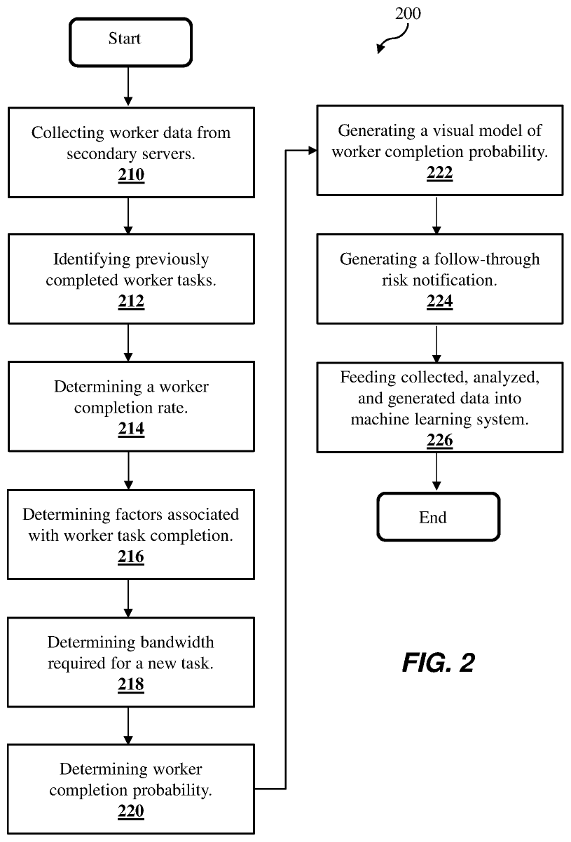

Referring to FIG. 2, a method 200 for project resource risk management is depicted, in accordance with an embodiment of the present invention.

Referring to block 210, the data collection module 150 collects the worker data 134a, 134b, 134c associated with one or more workers. Collection of the worker data 134a, 134b, 134c is described in more detail above with reference to the data collection module 150.

Referring to block 212, the task tracking module 152 identifies previous tasks completed by the one or more workers associated with the worker data 134a, 134b, 134c. Referring to block 214, the task tracking module 152 determines a worker task completion rate of the one or more workers associated with the worker data 134a, 134b, 134c. Referring to block 216, the task tracking module 152 determines factors associated with completed tasks by the one or more workers associated with the worker data 134a, 134b, 134c. Previous task completion identification, worker task completion, and completion associated factors are described in more detail above with reference to the task tracking module 152.

Referring to block 218, the new task analysis module 154 determines the bandwidth required for a new task to be assigned to a worker. New task analysis is described in more detail above with reference to the new task analysis module 154.

Referring to block 220, the worker analysis module 156 determines the probability that the one or more workers associated with the worker data 134a, 134b, 134c will complete a new task. Worker completion probability is described in more detail above with reference to the worker analysis module 156.

Referring to block 222, the data visualization module 158 generates a visual model of the worker completion probability for the one or more workers associated with the worker data 134a, 134b, 134c. Data visualization is described in more detail above with reference to the data visualization module 158.

Referring to block 224, the risk notification module 160 generates a follow-through risk notification for the one or more workers associated with the worker data 134a, 134b, 134c. The follow-through risk notification is described in more detail above with reference to the risk notification module 160.

Referring to block 226, the machine learning module 162 feeds collected, analyzed, and generated data from the data collection module 150, task tracking module 152, new task analysis module 154, worker analysis module 156, data visualization module 158, and risk notification module 160 into an existing machine learning system. Machine learning is described in more detail above with reference to the machine learning module 162.

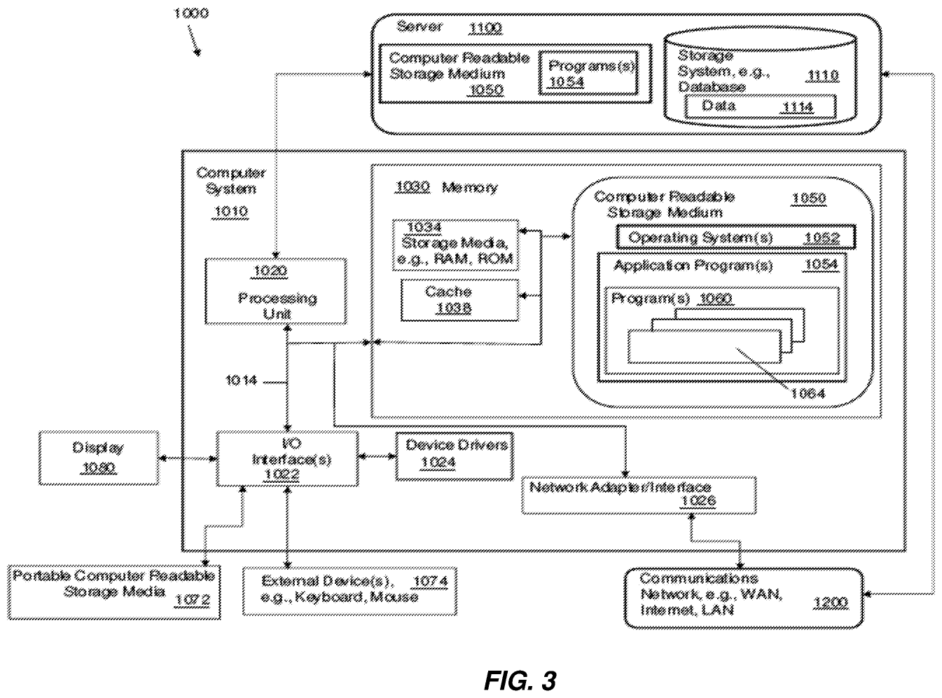

Referring to FIG. 3, a system 1000 includes a computer system or computer 1010 shown in the form of a generic computing device. The method 200 for example, may be embodied in a program(s) 1060 (FIG. 3) embodied on a computer readable storage device, for example, generally referred to as memory 1030 and more specifically, computer readable storage medium 1050 as shown in FIG. 3. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 4 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 3 as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 3, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method 200 (FIG. 2), for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

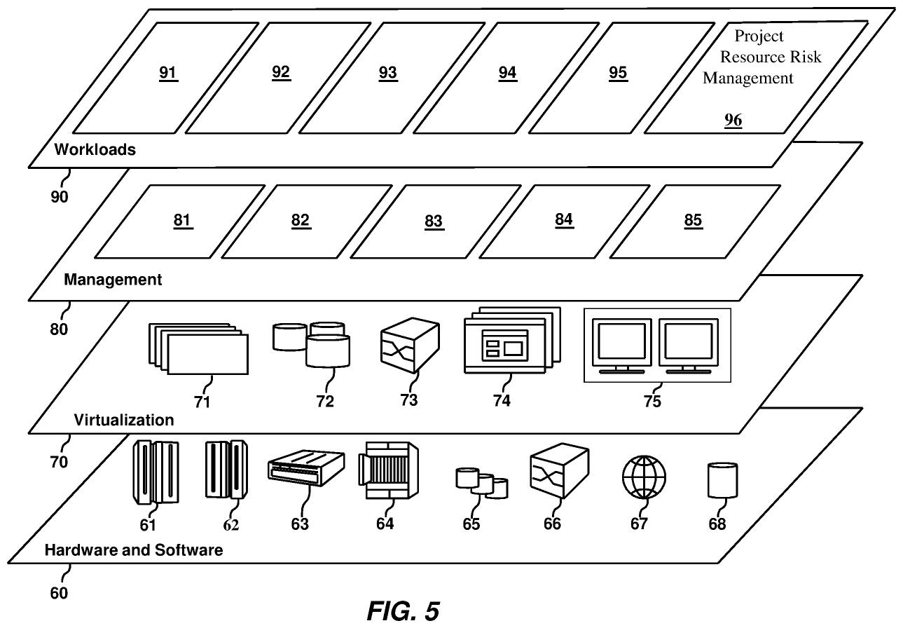

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and project resource risk management 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited and is merely provided to facilitate clear referencing of the method's steps. Furthermore, steps of the method may be performed in parallel to perform their described functionality.

What is claimed is:

1. A method for project resource risk management, the method comprising:
collecting, by a computing device, worker data associated with one or more workers;
identifying, by the computing device, previously completed tasks associated with the one or more workers from the worker data;
determining, by the computing device, a task completion rate for each one of the one or more workers; and
generating, by the computing device, a visual model illustrating the task completion rate of each of the one or more workers.

2. A method as in claim 1, further comprising:
determining, by the computing device, one or more factors associated with the previously completed tasks of one or more workers, wherein the factors comprise positive feedback, negative feedback, timelines of task completion, and length of task completion.

3. A method as in claim 1, further comprising:
receiving, by the computing device, a new task to be assigned to the one or more workers; and
determining, by the computing device, bandwidth required to complete the new task, wherein bandwidth comprises an estimated amount of time to complete the new task, resources necessary to complete the new task, and skills required to complete the new task.

4. A method as in claim 2, further comprising:
generating, by the computing device, a follow-through risk notification associated with each one of the one or more workers, wherein the follow-through risk notification indicates one or more of the factors associated with the previously completed tasks of one or more workers.

5. A method as in claim 1, wherein the worker data being worker comprises worker interactions associated with one or more computer applications.

6. A method as in claim 1, further comprising:
transmitting, by the computing device, the worker data, the task completion rate for the one or more workers, and the visual model to a machine learning system.

7. A method as in claim 1, wherein determining, by the computing device, a task completion rate for each one of the one or more workers further comprises:
generating, by the computing device, a probability model, the probability model consisting of at least one of a Markov model, a simple binary regression model, and a completion probability model.

8. A computer program product for project resource risk management, the computer program product comprising:
a computer-readable storage medium having program instructions embodied therewith, wherein the computer readable storage medium is not a transitory signal per se, the program instructions comprising:
program instructions to collect, by a computing device, worker data associated with one or more workers;
program instructions to identify, by the computing device, previously completed tasks associated with the one or more workers from the worker data;
program instructions to determine, by the computing device, a task completion rate for each one of the one or more workers; and
program instructions to generate, by the computing device, a visual model illustrating the task completion rate of each of the one or more workers.

9. A computer program product as in claim 8, wherein the program instructions further comprise:
program instructions to determine, by the computing device, one or more factors associated with the previously completed tasks of one or more workers, wherein the factors comprise positive feedback, negative feedback, timelines of task completion, and length of task completion.

10. A computer program product as in claim 9, wherein the program instructions further comprise:
program instructions to receive, by the computing device, a new task to be assigned to the one or more workers; and
program instructions to determine, by the computing device, bandwidth required to complete the new task, wherein bandwidth comprises an estimated amount of time to complete the new task, resources necessary to complete the new task, and skills required to complete the new task.

11. A computer program product as in claim 8, wherein the program instructions further comprise:
program instructions to generate, by the computing device, a follow-through risk notification associated with each one of the one or more workers, wherein the follow-through risk notification indicates one or more of the factors associated with the previously completed tasks of one or more workers.

12. A computer program product as in claim 9, wherein the worker data being worker comprises worker interactions associated with one or more computer applications.

13. A computer program product as in claim 8, wherein the program instructions further comprise:
program instructions to transmit, by the computing device, the worker data, the task completion rate for the one or more workers, and the visual model to a machine learning system.

14. A computer program product as in claim 8, wherein the program instruction to determine, by the computing device, a task completion rate for each one of the one or more workers further comprise:
program instructions to generate, by the computing device, a probability model, the probability model consisting of at least one of a Markov model, a simple binary regression model, and a completion probability model.

15. A computer system for project resource risk management, the system comprising:
one or more computer processors, one or more computer-readable storage media, and program instructions stored on one or more of the computer-readable storage media for execution by at least one of the one or more processors, the program instructions comprising:
program instructions to collect, by a computing device, worker data associated with one or more workers;
program instructions to identify, by the computing device, previously completed tasks associated with the one or more workers from the worker data;
program instructions to determine, by the computing device, a task completion rate for each one of the one or more workers; and
program instructions to generate, by the computing device, a visual model illustrating the task completion rate of each of the one or more workers.

16. A computer system as in claim 15, wherein the program instructions further comprise:
program instructions to determine, by the computing device, one or more factors associated with the previously completed tasks of one or more workers, wherein the factors comprise positive feedback, negative feedback, timelines of task completion, and length of task completion.

17. A computer system as in claim 16, wherein the program instructions further comprise:
program instructions to receive, by the computing device, a new task to be assigned to the one or more workers; and
program instructions to determine, by the computing device, bandwidth required to complete the new task, wherein bandwidth comprises an estimated amount of time to complete the new task, resources necessary to complete the new task, and skills required to complete the new task.

18. A computer system as in claim 15, wherein the program instructions further comprise:
program instructions to generate, by the computing device, a follow-through risk notification associated with each one of the one or more workers, wherein the follow-through risk notification indicates one or more of the factors associated with the previously completed tasks of one or more workers.

19. A computer system as in claim 16, wherein the worker data being worker comprises worker interactions associated with one or more computer applications.

20. A computer system as in claim 15, wherein the program instructions to determine, by the computing device, a task completion rate for each one of the one or more workers comprise:
program instructions to generate, by the computing device, a probability model, the probability model consisting of at least one of a Markov model, a simple binary regression model, and a completion probability model.
